(19) United States
(12) Patent Application Publication
(10) Pub. No.: US 2003/0185096 A1
(43) Pub. Date: Oct. 2, 2003

(54) Apparatus and methods for dispensing minute amounts of liquid

(76) Inventors: Thomas E. Hollstein, Hill Drive, OH (US); Margaret M. Ruminski, Garfield Heights, OH (US); James C. Smith, Rock Creek Run, OH (US); Michael A. Zgayb, Lorain, OH (US); James W. Messerly, Stow, OH (US); John C. Dillon, Lorain, OH (US); Timothy E. Wilson, Huron, OH (US)

Correspondence Address: Calfee Halter & Griswold, 1400 McDonald Investment Center, 800 Superior Avenue, Cleveland, OH, 44114-2688, US

(21) Appl. No.: 10/296,673

(22) PCT Filed: Jun. 4, 2001
(86) PCT No.: PCT/US01/40840

(51) Int. Cl. B01F 13/08

(52) U.S. Cl. 366/273

(57) ABSTRACT

A dispensing apparatus is provided that dispenses minute quantities of liquid material, such as, for example, pharmaceutical suspensions, while maintaining substantial homogeneity of the suspension. In one embodiment, the apparatus includes a mixing device that stirs, agitates or otherwise imparts motion to the suspension that is contained in a reservoir. For example, a mixing device is realized in the form of a magnetic impeller, mixer or stirrer that is disposed within the suspension. A series of magnets external to the reservoir are rotated to produce a rotating magnetic field that induces rotation of the impeller.

### RELATED APPLICATIONS

This application claims the benefit of pending U.S. Provisional patent application Serial Nos. 60/209,537 filed on Jun. 5, 2000 for APPARATUS AND METHODS FOR DISPENSING MINUTE AMOUNTS OF LIQUID MATERIAL, and 60/210,309 filed on Jun. 8, 2000 for APPARATUS AND METHODS FOR DISPENSING MINUTE AMOUNTS OF LIQUID MATERIAL; the entire disclosures of which are fully incorporated herein by reference.

### TECHNICAL FIELD OF THE INVENTION

The present invention relates to apparatus and methods for dispensing very small quantities of a liquid material. More particularly, the invention relates to dispensing a solid material that is suspended in a liquid solvent such that the suspension is maintained homogenous.

### BACKGROUND OF THE INVENTION

Drugs and medicines are commonly administered in pill form or with hypodermic injections. Many patients dislike or have difficulty taking pills or receiving shots. Therefore, there is an interest in administering pharmaceuticals by inhalation, which avoids the unpleasantness of shots and pills and also increases the speed at which the medicine is absorbed into the patient's bloodstream.

In order to administer drugs by inhalation, very small amounts of the drug must be deposited on a substrate or carrier. Typically, the drugs are in powder form, but the drug may only be needed in very small weights, such as about 5 to 500 microgram doses. Known dispenser apparatus cannot accurately dispense powders in such minute quantities. Particularly in the pharmaceutical field, it is also very important that each dose be dispensed accurately by weight.

It is proposed to dispense such powders by first mixing the powder in a suspension consisting of an appropriate solution of solvents and the powder. The powder does not dissolve into a solution, but rather is present in a suspension. The liquid suspension is dispensed onto an appropriate substrate, and the solvents then evaporate away, leaving only the powder on the substrate. In order to remove the solvents entirely and quickly, highly volatile solvents are used. The use of such solvents presents various problems, including the difficulty in keeping the solid powder material in a homogenous suspension. The solid powder material tends to settle out from the solvents. This results in a loss of homogeneous dispersion of the solid material in the suspension. This lack of homogeneity can greatly impact the weight of the powder dispensed onto the substrate.

The need exists, therefore, for dispensing apparatus and methods that effectively can dispense minute quantities of a suspension onto a substrate while maintaining a homogenous quality of the suspension.

### SUMMARY OF THE INVENTION

In accordance with one aspect of the invention, a dispensing apparatus is contemplated that dispenses minute quantities of liquid material, such as, for example, pharmaceutical suspensions, while maintaining substantial homogeneity of the suspension. In one embodiment, the apparatus includes a mixing device that stirs, agitates or otherwise imparts motion to the suspension that is contained in a reservoir. More specifically, a mixing device is realized in the form of a magnetic impeller, mixer or stirrer that is disposed within the suspension. A series of magnets external to the reservoir are rotated to produce a rotating magnetic field that induces rotation of the impeller.

In accordance with another aspect of the invention, the suspension is modified by increasing the concentration of the solid material in the suspension such that the solid material remains in a homogeneous suspension. In accordance with a further aspect of the invention, a pressure sensor is provided near the dispensing nozzle to detect proper operation of the nozzle.

These and other aspects and advantages of the present invention will be apparent to those skilled in the art from the following description of the preferred embodiments in view of the accompanying drawings.

### BRIEF DESCRIPTION OF THE DRAWINGS

The invention may take physical form in certain parts and arrangements of parts, preferred embodiments and a method of which will be described in detail in this specification and illustrated in the accompanying drawings which form a part hereof, and wherein:

FIG. 1 illustrates in partial longitudinal cross-section a dispensing gun in accordance with the invention;

FIG. 2 is an enlarged illustration of the lower or nozzle end of the gun of FIG. 1;

FIG. 3 is a simplified schematic representation of a mixing or agitation device in accordance with the invention;

FIGS. 4A-4D illustrate alternative embodiments for a mixing/agitation device in accordance with the invention;

FIG. 5 is a simplified schematic of a typical application for the gun illustrated in FIG. 1; and

FIG. 6 is a simplified illustration in partial longitudinal cross-section of an alternative embodiment of the invention.

### DETAILED DESCRIPTION OF THE INVENTION

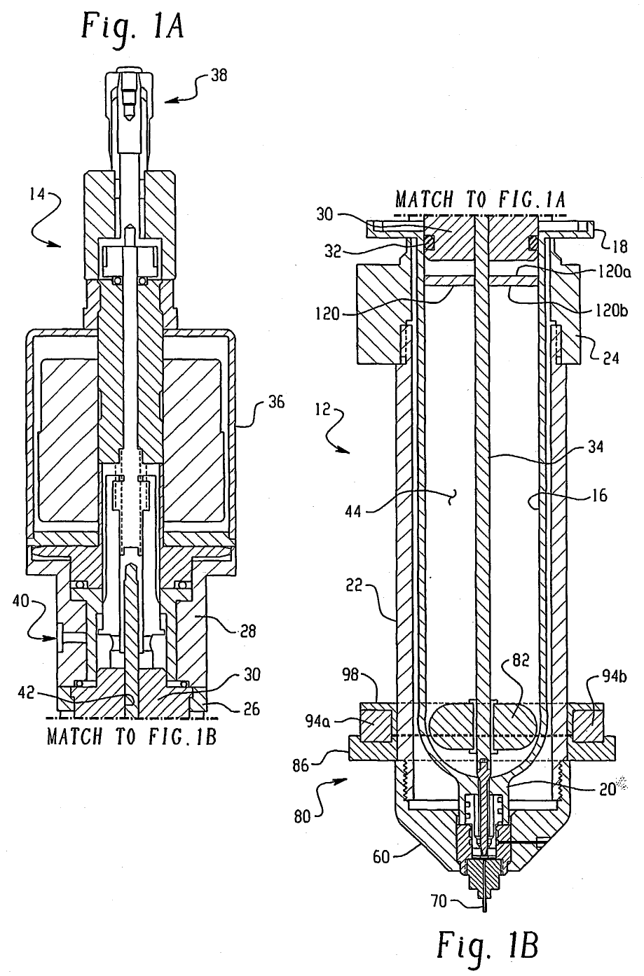

With reference to FIG. 1, an embodiment of a dispensing gun that incorporates the invention is illustrated and indicated generally with the numeral 10. While the invention is described herein with reference to specific embodiments of the dispensing gun, such descriptions are intended to be exemplary in nature and should not be construed in a limiting sense. The various aspects of the invention may be used with a wide variety of gun designs; furthermore, the various aspects of the invention may be used individually or in any combination thereof.

The gun 10 includes a dispenser section 12 and a dispensing actuator 14. The basic gun design in this example is an Accura Jetter™ dispensing gun available from Nordson Corporation, Amherst, Ohio. This gun is described in U.S. Pat. No. 5,074,443 the entire disclosure of which is fully incorporated herein by reference. The dispenser section 12 includes a dispensing cartridge or syringe 16 in the form of a generally thin walled plastic cylindrical tube or reservoir having a mounting flange 18 at a fill end and a nipple 20 at an outlet end. The cartridge 16 is longitudinally disposed in a syringe support tube 22. The support tube 22 is threaded at both ends, and at one end is threadably mounted on a syringe bracket assembly 24. The bracket 24 is mated with a retainer 26 that is attached to a support bracket 28. A syringe adapter or boss 30 is installed in and held by the retainer 26. The adapter 30 includes an o-ring or other suitable seal 32. The cartridge 16 is slipped onto the adapter 30 over the seal 32, with the flange 18 being captured between the bracket 24 and the body 28. In this manner the cartridge 16 is securely supported within the support tube 22.

An elongated needle 34 extends centrally through the cartridge 16 and is operably mounted within the actuator 14. In this embodiment, the actuator 14 is realized in the form of a solenoid actuator 36. A micrometer adjustment device 38 is provided to permit the operator to adjust how far the needle 34 opens the outlet nozzle (discussed below).

An air inlet port 40 is provided with a suitable fitting (not shown). Pressurized air passes into the support bracket 28 at the inlet port 40. The needle 34 loosely fits through a bore 42 in the adapter 30 so that the pressurized air that is fed to the bracket 28 from the inlet port 40 can pass around the needle 34 and into the cartridge 16 interior volume 44. The cartridge 16 holds the liquid material that is to be dispensed.

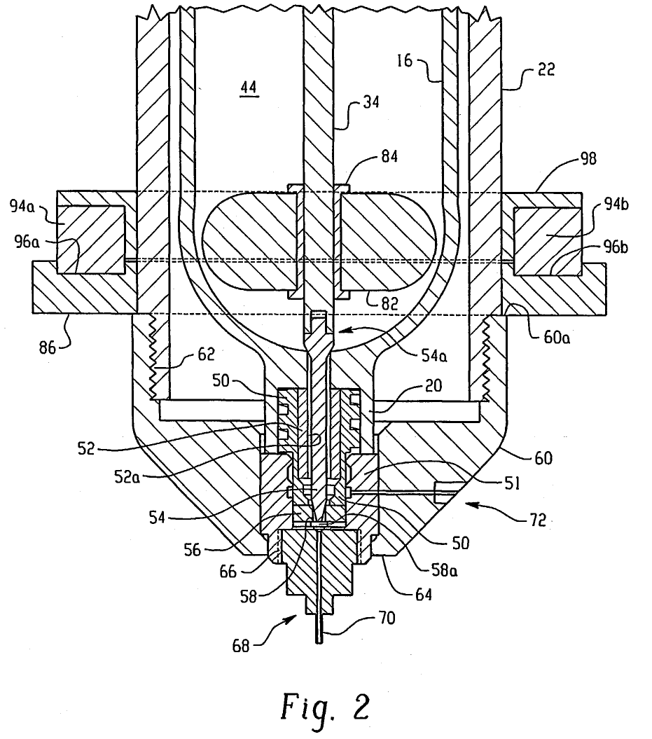

With reference to FIG. 2, the cartridge nipple 20 is internally threaded and receives a threaded leur lock 50. The nipple 20 may also include a needle support sleeve 52 integrally formed in the nipple 20. The sleeve 52 includes a central bore 52a through which the liquid material passes from the cartridge interior volume 44. The needle 34 includes a valve needle 54 that is welded (as at 54a) or otherwise attached to or integral with the main needle body 34. The leur lock 50 holds a valve seat 56. The valve needle 54 cooperates with the seat 56 to control flow of the liquid material through a central bore 58 in the valve seat 56 that forms an outlet orifice 58a. A support cap 60 is assembled onto a threaded end 62 of the support tube 22 and includes an inward flange 64 that engages the leur lock 50 and supports the syringe cartridge 16 assembly. An alignment insert 51 is press fit into the cap 60 to maintain alignment of the needle 34 and the seat 56. The leur lock 50 includes a threaded bore 66. A nozzle assembly 68 is installed in the threaded retainer bore 66. The nozzle assembly 68 may include an elongated nozzle 70 in the form of a hollow tube that is in fluid communication with the outlet orifice 58a.

Operation of the gun 10 is straightforward. The solenoid 36 is used to seat and unseat the valve needle 54 from the valve seat 56. As the needle 54 is withdrawn from the seat 56, the liquid material can flow out the nozzle 70. Pressurized air enters the upper portion or head space of the cartridge volume 44 to assist in accurate control of the volume of material dispensed from the gun 10. The invention may be realized, however, with any number of known valve designs and valve actuators if so required.

In the pharmaceutical field, it is desired to dispense very minute quantities of a drug, for example about 5 to 500 micrograms by weight. The object is to dispense these very small quantities onto a substrate or carrier for the drug. In one example, the drug is dispensed onto a blister strip, with each dose in a separate blister. In order for the drug to be in pure powder form after being dispensed, it is put into a suspension of volatile solvents, such as, for example, in hexane and perfluoromethylcyclohexane (PFMCH). The actual solvent selected will be determined by the drug's physical properties. Testing of the gun 10 is typically performed with a placebo suspension. The present invention has been successfully tested with a suspension of hydroxynaphthoic acid (HNA) in hexane and perfluoromethylcyclohexane (PFMCH). A typical characteristic of the drug and placebo suspensions is that the solid material (e.g. the drug, or in the case of the placebo, HNA) does not readily stay in suspension in the solvents. The volatile solvents are used so that as soon as the liquid material is dispensed, the solvents evaporate and all that is left is the pure drug on the substrate. If the drug settles out of the suspension prior to dispensing, the concentration of the drug within each dispensed quantity may vary, which is an undesirable condition.

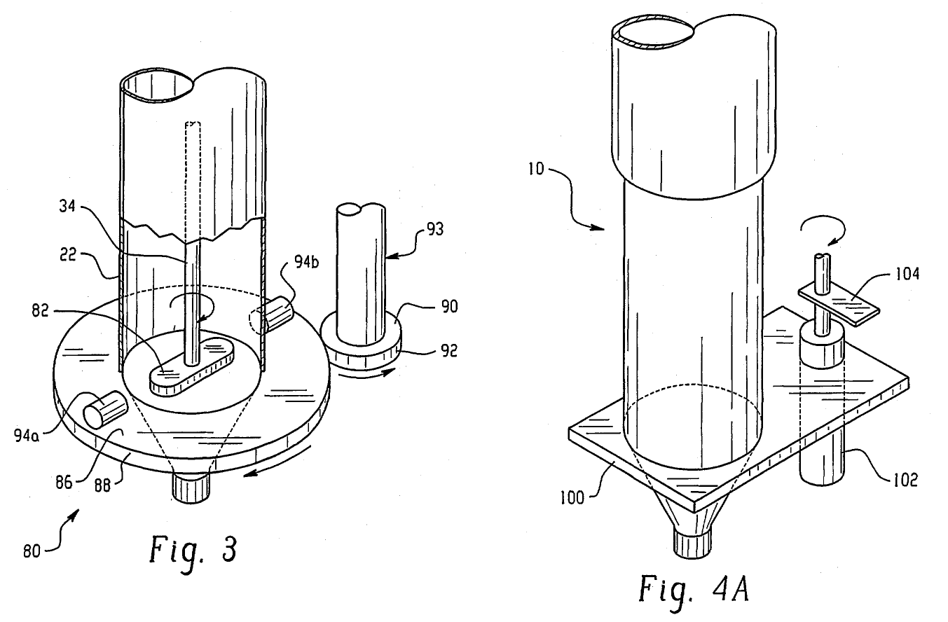

It is important, therefore, that the homogeneity of the suspension in the reservoir be substantially maintained. In accordance with this aspect of the invention, a mixing device 80 or other agitation mechanism is included with the gun 10. With reference to FIG. 3, the mixing device 80 may be realized in the form of a magnetic stirrer 82 that is mounted on the needle 34 within the suspension. The magnetic stirrer may be realized, for example, in the form of a bar magnet. The bar magnet 82 is provided with a central hole through which the needle 34 passes. The bar magnet 82 may include blades of variable pitch or be formed in the shape of a blade to enhance the mixing action. As best illustrated in FIG. 2, a retainer clip or other suitable retainer 84 is used to support the magnet 82 on the needle 34.

A non-magnetic driven gear 86 is mounted on the support tube 22 in the region of the magnetic stirrer 82. For example, as best shown in FIG. 2, the gear 86 rests on an outer shoulder 60a formed on the support cap 60. The driven gear 86 includes a series of peripheral gear teeth 88 that operably mesh with corresponding gear teeth 92 of a drive gear 90. The drive gear 90 may be driven by any suitable motor 93 such as an electric motor, an air motor and so on.

The driven gear 86 carries a plurality of permanent magnets 94, in this embodied two rare earth magnets 94a and 94b. Rare earth magnets provide a strong magnetic field which overcomes the gap between the magnets 94a and the stirrer 82. In the embodiment of FIG. 2, the magnets 94a,b are disposed in respective recesses 96a,b in the driven gear 86, and a cover 98 is used to securely retain the magnets 94a,b on the gear 86.

As the drive gear 90 is rotated, the driven gear 86 rotates the magnets 94 about the support tube 22, and the associated rotating magnetic field of the magnets 94 imparts rotating motion to the stirrer 82. This stirring action imparts sufficient mixing and agitation within the cartridge 16 to maintain the solid material in a homogenous suspension. We have found that a speed of as little as about 25 revolutions per minute is sufficient to maintain the homogeneity of the suspension.

It is important to note that the present invention is not limited to the specific embodiments and descriptions of the stirring technology in the exemplary embodiments. For example, the stirring need not be a continuous operation, either before, during or after the dispensing action. Rather the stirring may be applied periodically for selectable periods of time, for example, in order to best maintain a homogenous suspension for dispensing. Furthermore, various aspects of the invention as described herein are not to be construed as having to be used all together or in any particular combination, but rather may be used individually or in various combinations as required for a particular dispensing apparatus or process. For example, the concept of agitating or stirring the suspension can be realized with or without the use of a pressure fed suspension or with or without the needle valve control arrangement.

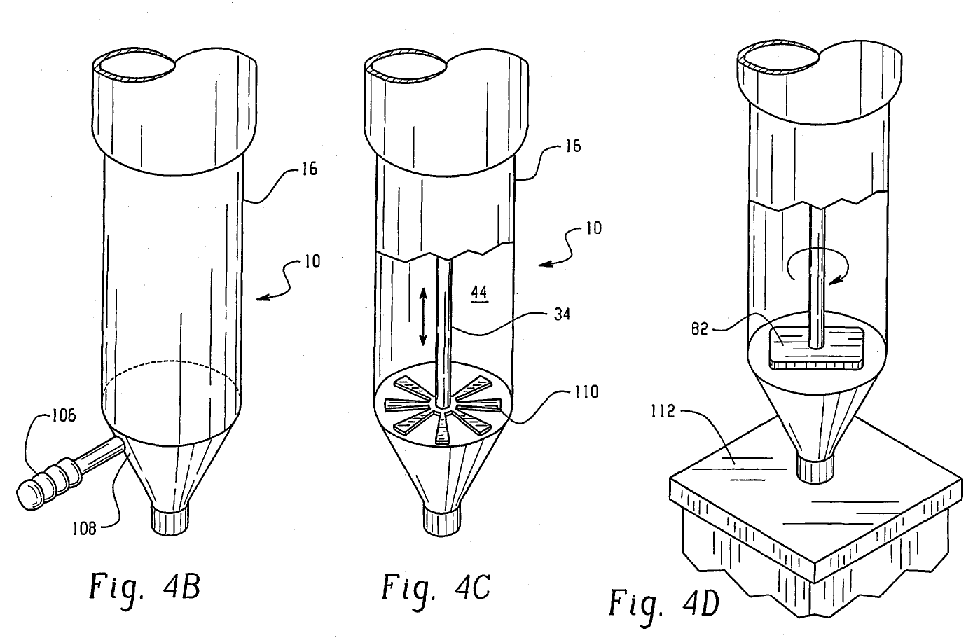

FIGS. 4A-4D illustrate alternative mixing and agitation devices that may be used. In FIG. 4A, the gun 10 extends through an agitator plate 100. A motor 102 is mounted on the plate 100 and spins an off-center weight 104. This produces a vibration in the plate 100 that agitates the suspension within the gun 10. In FIG. 4B, a bellows 106 is used to periodically impart fluid motion to the suspension through a port 108 in the cartridge 16 (the bellows would be external to the cartridge 16 and the support tube 22). In the embodiment of FIG. 4C, a non-rotating impeller blade 110 is mounted on the needle 34. As the needle 34 is actuated, its movement causes displacement of the blade 110 to agitate the suspension. In FIG. 4D, the magnetic stirrer 82 is used in a manner similar to the embodiment of FIG. 3, however, rotary motion is imparted to the stirrer by the use of a magnetic drive unit 112 that produces a rotating magnetic field. The magnetic drive unit 112 may be, for example, model no. S46725 available from Cimarec. Alternatively still further, an armature may be positioned about the support tube to provide an electrically controlled rotating magnetic field to drive the stirrer 82. Other agitation or motion imparting techniques will be readily apparent to those skilled in the art.

In addition to mechanical agitation or mixing to maintain a homogenous suspension within the cartridge 16, homogeneity may be maintained by a proper selection of the concentration of the solid material in the suspension. For example, in the case of the placebo HNA in a suspension with hexane and PFMCH, we have found that a concentration of about 1500 milligrams of HNA in 4 milliliters of hexane and 5.2 milliliters of PFMCH maintains homogeneity of the suspension whereby the HNA does not settle out.

With reference again to FIG. 1, as described herein above, pressurized air is applied to the upper portion of the cartridge volume 44 to assist in dispensing the suspension through the nozzle 70. As the liquid material is dispensed, the surface level of the suspension within the cartridge 16 drops, leaving a head space above the surface level. The volatile nature of the solvents used in the suspension may result in the solvents evaporating into the head space which is filled with the pressurized air. In order to reduce this head space, and in accordance with another aspect of the invention, a piston follower 120 in the form of a plastic or other suitable material disk may be provided with a hole through which the needle 34 extends. The piston 120 is adapted to slide axially within the cartridge 16 along the axis of the needle 34 with a lower surface thereof 120b in contact with the surface of the suspension in response to the pressurized air that acts on the upper surface 120a of the piston 120. In this manner, the pressurized air is isolated from the suspension by the piston 120.

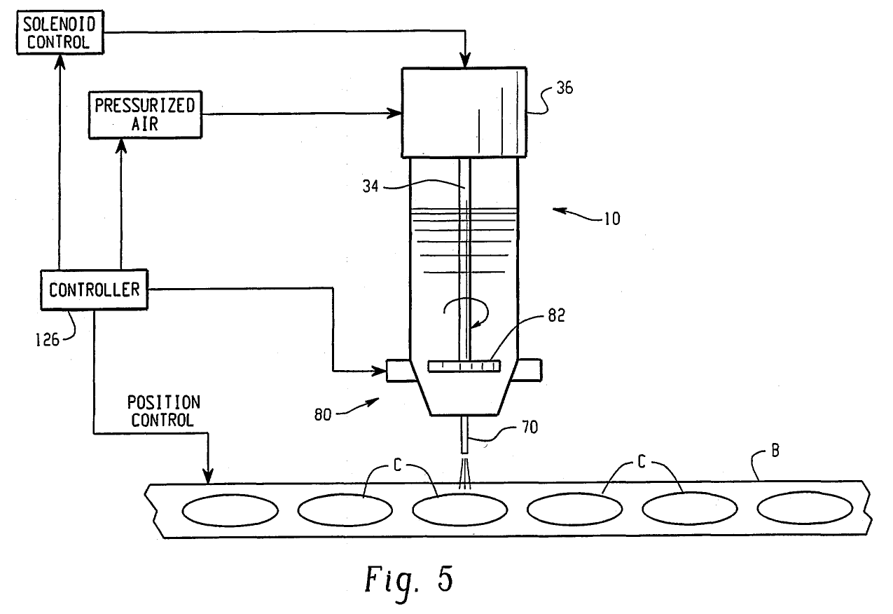

With reference to FIG. 5, in a typical dispensing operation the gun 10 is supported on a suitable stationary stand or alternatively may be mounted on a movable platform (not shown). The gun 10 is positioned such that the nozzle 70 is in fairly close proximity to a blister strip B having a series of blister is actuated, its movement causes displacement of the blade 110 to agitate the suspension. In FIG. 4D, the magnetic stirrer 82 is used in a manner similar to the embodiment of FIG. 3, however, rotary motion is imparted to the stirrer by the use of a magnetic drive unit 112 that produces a rotating magnetic field. The magnetic drive unit 112 may be, for example, model no. S46725 available from Cimarec. Alternatively still further, an armature may be positioned about the support tube to provide an electrically controlled rotating magnetic field to drive the stirrer 82. Other agitation or motion imparting techniques will be readily apparent to those skilled in the art.

In addition to mechanical agitation or mixing to maintain a homogenous suspension within the cartridge 16, homogeneity may be maintained by a proper selection of the concentration of the solid material in the suspension. For example, in the case of the placebo HNA in a suspension with hexane and PFMCH, we have found that a concentration of about 1500 milligrams of HNA in 4 milliliters of hexane and 5.2 milliliters of PFMCH maintains homogeneity of the suspension whereby the HNA does not settle out.

With reference again to FIG. 1, as described herein above, pressurized air is applied to the upper portion of the cartridge volume 44 to assist in dispensing the suspension through the nozzle 70. As the liquid material is dispensed, the surface level of the suspension within the cartridge 16 drops, leaving a head space above the surface level. The volatile nature of the solvents used in the suspension may result in the solvents evaporating into the head space which is filled with the pressurized air. In order to reduce this head space, and in accordance with another aspect of the invention, a piston follower 120 in the form of a plastic or other suitable material disk may be provided with a hole through which the needle 34 extends. The piston 120 is adapted to slide axially within the cartridge 16 along the axis of the needle 34 with a lower surface thereof 120b in contact with the surface of the suspension in response to the pressurized air that acts on the upper surface 120a of the piston 120. In this manner, the pressurized air is isolated from the suspension by the piston 120.

With reference to FIG. 5, in a typical dispensing operation the gun 10 is supported on a suitable stationary stand or alternatively may be mounted on a movable platform (not shown). The gun 10 is positioned such that the nozzle 70 is in fairly close proximity to a blister strip B having a series of blister depressions or cavities C. Each cavity C receives a single dose of the dispensed medicine. A single dose may be made by a plurality of deposits in a blister. The blister strip B may be mounted on a suitable device that indexes and moves the strip B relative to the nozzle 70. A control mechanism 126 for the blister strip position may also be used to control a pressurized air source 122 and the solenoid 36 control 124 and operation of the mixing device 80, such as controlling the operation of the drive motor 93 (FIG. 3). Any conventional controller or control circuit arrangement may be used as required and as is well known to those of ordinary skill in the art.

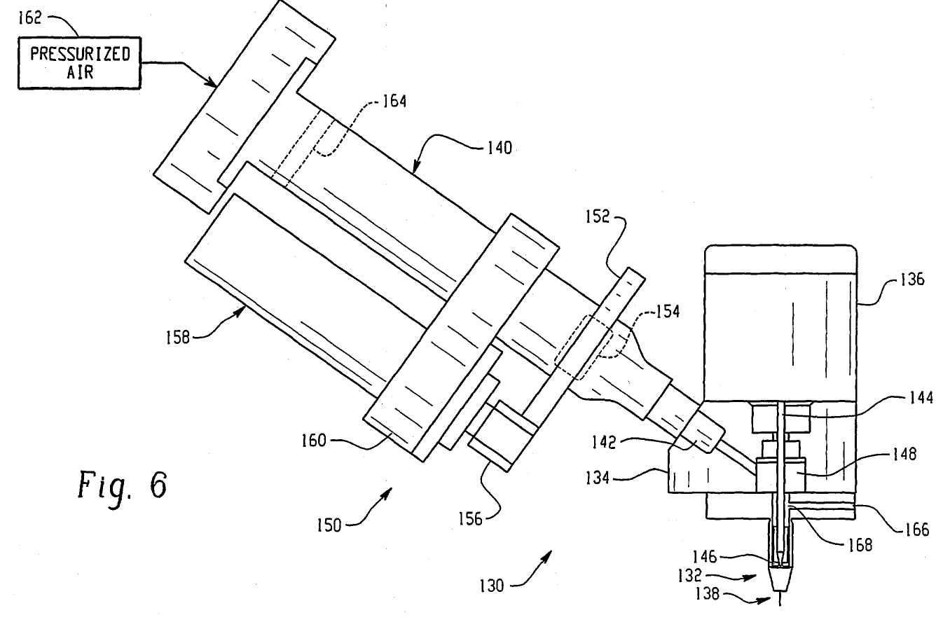

With reference to FIG. 6 there is illustrated an alternative embodiment for the dispensing gun. In this embodiment, the dispensing gun and the cylinder that holds the liquid material to be dispensed are separated. Thus, the cylinder may be removed and refilled without having to disassemble the dispensing gun itself.

In the embodiment of FIG. 6, the dispensing gun 130 may be a Dispense Jet™ gun available from Nordson Corporation, Amherst, Ohio but modified as described herein. The basic gun is described in U.S. Pat. No. 5,747,102 the entire disclosure of which is fully incorporated herein by reference. The Dispense Jet gun 130 is a solenoid driven needle valve style gun or ball and seat valve with the valve mechanism 132 disposed in a manifold block 134. The manifold block 134 supports a valve actuator 136, in this case an electric solenoid. The valve mechanism 132 is in fluid communication with a dispensing nozzle assembly 138.

The gun 130 further includes a dispensing cylinder 140 which may be the same as the cylinder 16 in FIG. 1. However, since the cylinder 140 is no longer integral with the gun valve mechanism,there is no need for the outer support tube (element 22 in FIG. 1.) The cylinder 140 may be installed into a threaded hole 142 in the manifold block 134. The solenoid 136 operates a needle 144 which seats against a valve seat 146 to control flow of the liquid material through the nozzle assembly 138. The liquid material flows from the cylinder 140 into a chamber 148 and around the needle 144 through the valve seat 146 when the valve is open and down to the nozzle 138.

In accordance with another aspect of the invention, the cylinder 140 is equipped with a mixing or agitation device 150. In the embodiment of FIG. 6, the mixing device 150 is the same as in the embodiment of FIG. 3, including a driven gear 152 that retains rare earth magnets that produce a magnetic field that impel rotary motion to a magnetic stirrer 154 within the cylinder 140. Since there is no needle in the cylinder 140, the magnetic stirrer 154 may be supported therein by any other convenient mechanism such as a centrally located support rod (not shown). The driven gear 152 is driven by a drive gear 156 that is rotated by a drive motor 158. The motor 158 may be supported on the cylinder 140 by a suitable bracket 160. Pressurized air from a source 162 is provided at one end of the cylinder 140 to assist in dispensing the liquid material. To reduce head space, a piston follower 164 may be provided as described herein with reference to FIG. 1.

By providing the dispensing syringe cylinder 140 separate from the valve assembly on the manifold block 134, the cylinder 140 may be easily replaced and refilled without having to disassemble the valve device.

In accordance with another aspect of the invention, pressure sensing during a dispensing operation is performed. In the embodiment of FIGS. 1 and 2, for example, the manifold block 134 includes a pressure port 166 that provides access for a pressure transducer 168. The pressure transducer 168 is preferably but not necessarily disposed near the needle and valve seat 144, 146 assembly. A suitable pressure transducer is available from GP50 Corporation. Since the liquid material being dispensed is non-circulating, there is a head pressure of the fluid within the manifold 134 when the valve is closed. When the valve needle 144 is pulled away from the seat 146 to open the valve and permit flow, there will be a small pressure drop that is detected by the pressure transducer 168. The pressure transducer output signal may be monitored by a controller or operator for automatic verification that the gun is properly triggering and operating properly to dispense fluid. The pressure transducer 168 may also be used with the gun 10 of FIG. 1 via a pressure port 72.

The invention has been described with reference to exemplary embodiments. Modifications and alterations will occur to others upon a reading and understanding of this specification. It is intended to include all such modifications and alterations insofar as they come within the scope of the appended claims or the equivalents thereof.

We claim:

1. Apparatus for dispensing suspensions of solid material in a solvent, comprising:
a dispenser for holding a quantity of the suspension;
a valve that controls flow of the suspension from said dispenser; and
means for imparting motion to the suspension within said dispenser.

2. The apparatus of claim 1 wherein said motion means operates to maintain a generally uniform dispersion of the material in the solvent.

3. The apparatus of claim 1 wherein said motion means comprises a stirring device disposed within said dispenser.

4. The apparatus of claim 3 wherein said stirring device moves in response to a magnetic field.

5. The apparatus of claim 4 wherein said stirring device comprises a magnetic impeller.

6. The apparatus of claim 4 comprising a rotating magnetic field that causes a rotation of said stirring device.

7. The apparatus 4 comprising at least one magnetic element disposed outside said dispenser and mounted for rotation about said dispenser to impart motion to said stirring device.

8. The apparatus of claim 7 comprising a motor for rotating said magnetic device.

9. The apparatus of claim 1 wherein said dispenser is mounted on a plate, and wherein said means operates to shake said plate and dispenser.

10. The apparatus of claim 1 wherein said means comprises a bellows.

11. The apparatus of claim 1 wherein said means comprises a magnetic stirrer that is disposed within said dispenser and that is submerged in the suspension, and a rotating magnetic field disposed outside said dispenser; said stirrer moving in response to said magnetic field.

12. The apparatus of claim 11 comprising a magnetic drive unit that produces said rotating magnetic in response to an electrical control signal.

13. The apparatus of claim 11 comprising at least one magnet disposed on a driven gear, and a motor for rotating said gear to produce said rotating magnetic field.

14. The apparatus of claim 1 wherein said valve is disposed at an outlet orifice of said dispenser.

15. The apparatus of claim 14 wherein said valve comprises a needle valve with a needle member extending longitudinally through said dispenser.

16. The apparatus of claim 15 comprising a magnetic stirrer rotatably mounted on said needle member.

17. The apparatus of claim 15 comprising a magnetic stirrer rotatably mounted on said needle member.

18. The apparatus of claim 1 wherein said valve is disposed in a valve assembly having a valve chamber, said dispenser having an outlet orifice that opens to said chamber, said dispenser being installable on said valve assembly separately from said valve.

19. The apparatus of claim 1 comprising pressurized air for assisting flow of the suspension from said dispenser.

20. The apparatus of claim 19 comprising a pressure plate that moves under force of said pressurized air, said plate having a surface that contacts the suspension to apply a dispensing force thereto.

21. The apparatus of claim 20 wherein said pressure plate minimizes head space above a surface of the suspension inside said dispenser.

22. The apparatus of claim 1 wherein the solid material comprises a pharmaceutical substance.

23. The apparatus of claim 22 wherein the solvent is volatile and rapidly evaporates upon exposure to air.

24. The apparatus of claim 23 wherein the solvent comprises hexane and perfluoromethylcyclohexane (PFMCH).

25. The apparatus of claim 1 wherein said valve comprises an outlet nozzle, and a blister board positioned near said nozzle so that the suspension is selectively dispensed onto said blister board.

26. The apparatus of claim 25 comprising a control system that positions and moves said blister board and valve relative to each other.

27. A method for dispensing a suspension of a solid material in a solvent, comprising the steps of:
placing a quantity of the suspension in a reservoir;
transferring a portion of the suspension from the reservoir to a surface; and
imparting movement to the suspension in the reservoir to maintain a generally uniform dispersion of the solid material in the solvent while the suspension is being dispensed.

28. The method of claim 27 wherein the step of imparting movement comprises stirring the suspension within the reservoir.

29. The method of claim 28 comprising the step of stirring the suspension with an impeller that is rotated by a magnetic field.

30. The method of claim 27 wherein said transferring step comprises the step of opening a valve to allow the suspension to flow from the reservoir to the surface.

31. The method of claim 27 comprising the step of applying pressure to the suspension to facilitate flow of the suspension from the reservoir.

32. Apparatus for dispensing a liquid material, comprising:
a reservoir for holding a quantity of the liquid;
a valve for controlling flow of the liquid from said reservoir to a surface; and
an agitation device for imparting motion to the suspension during a dispensing sequence.

33. The apparatus of claim 32 wherein said agitation device comprises a stirrer disposed within said reservoir.

34. The apparatus of claim 33 wherein said stirrer is driven by a magnetic field.

35. The apparatus of claim 34 comprising means for producing a rotating magnetic field exterior said reservoir.

36. The apparatus of claim 32 wherein said valve comprises a valve seat installed at an outlet of said reservoir.

37. The apparatus of claim 36 wherein said valve comprises a valve needle installed in said reservoir.

38. The apparatus of claim 32 comprising a pressure source applying pressure to the suspension in said reservoir during a dispensing operation.

39. The apparatus of claim 38 comprising a pressure plate that applies pressure to a surface of the suspension during a dispensing operation, thereby substantially eliminating head space.

40. The apparatus of claim 39 comprising pressurized air applying a force against said pressure plate to pressurized the suspension.

41. Apparatus for dispensing a pharmaceutical suspension of a solid material in a volatile solvent, comprising:
a dispensing tube for holding a quantity of the suspension;
an agitation device in said tube for stirring the suspension to maintain a generally uniform dispersion of the solid material in the solvent; and
a control device that controls flow of a portion of the suspension from said tube to a surface.

42. Apparatus for dispensing a pharmaceutical suspension onto a surface, comprising:
a dispenser that holds a quantity of the suspension;
a control device that controls flow of the suspension from the dispenser to the surface; and
a magnetically driven stirring element installed in said dispenser to maintain a generally uniform homogeneity of the suspension during a dispensing operation.

43. Apparatus for dispensing a pharmaceutical suspension, comprising:
a dispenser that holds a quantity of the suspension;
a needle valve in said dispenser that controls flow of the suspension from said dispenser to a surface; and
a magnetically driven agitator that is disposed in said dispenser and that maintains the suspension generally homogenous during a dispensing operation.

44. A method for dispensing a pharmaceutical suspension to a surface, comprising the steps of:
placing a quantity of the suspension in a dispensing tube;
controlling selective transfer of a portion of the suspension to the surface as a dispensing operation;
agitating the suspension as part of a dispensing operation; and
applying pressure to the suspension during a dispensing operation.
